(19) United States
(12) Patent Application Publication
(10) Pub. No.: US 2016/0075093 A1
(43) Pub. Date: Mar. 17, 2016

(54) PROCESS FOR PRODUCING A COMPOSITE TUBE

(71) Applicant: VOITH PATENT GMBH, Heidenheim (DE)

(72) Inventors: JUERGEN BRUEHLER, TRAUNREUT (DE); BENJAMIN SEIP, MUENCHEN (DE); PATRICK TICHELMANN, HALLBERGMOOS (DE)

(21) Appl. No.: 14/786,231

(22) PCT Filed: Apr. 17, 2014
(86) PCT No.: PCT/EP2014/057863

§ 371 Date: Oct. 22, 2015

Related U.S. Application Data
(60) Provisional application No. 61/815,009, filed on Apr. 23, 2013.

(30) Foreign Application Priority Data
Apr. 22, 2013 (DE) 10 2013 207 203.1

(51) Int. Cl. B29C 70/46; B29C 70/54; F16L 9/128; B29D 23/00

(52) U.S. Cl. CPC B29C 70/462; B29D 23/001; B29C 70/54; F16L 9/128; B29K 2063/00

(57) ABSTRACT

A tube of fiber-reinforced plastic has a fitting face. A process for producing the tube includes the following steps: a) winding a fiber reinforcing material onto a winding core and applying a matrix material to form the tube; b) centering a fitting shaping tool in relation to the winding core; c) pushing the fitting shaping tool in the axial direction onto the later fitting face, which is formed on an annular part of the external circumferential face of the tube, wherein the fitting shaping tool rotates relative to the tube and to the winding core at least temporarily as it is being pushed on; d) thermally treating the tube in a furnace to cure the matrix material. The shaping tool remains in contact with the part of the external circumferential face during the thermal treatment and generates a defined surface on the outer side of the tube.

The invention relates to a process for producing a tube made of fiber-reinforced plastic, in which the tube is formed by winding a fiber reinforcing material onto a winding core and applying a matrix material, and to a tube produced in this way.

Such processes are already familiar, for example, for the production of rolls of composite material. The winding core in this case defines the internal surface of the tube and generates a corresponding surface accuracy and surface quality. The outer side of the tube retains an irregular curvature after winding and curing in the furnace. Mechanical finishing has until now been necessary in order to generate a defined, smooth surface on the outer side of the tube. A corresponding surface is generated either by turning or by grinding. This is disadvantageous, since additional elaborate processing steps are necessary. Only matrix material can be removed, furthermore, since the fiber reinforcement must not be damaged. This imposes a limitation on the design.

Also familiar from DE 2342593 A is a process for producing conical tubes from glass fiber-reinforced polyester resin, in which it is possible to dispense with subsequent machining of the surface. After winding the tube onto a winding core, and before curing, a press sleeve is applied from the outer side or is pushed on axially for the entire length of the tube, so that the tube material is compressed. It is then cured. A disadvantage associated with this familiar process is that no particularly accurate surfaces can be produced. There is also no requirement for this, however, for tubes that are used as masts.

The object of the invention is to further develop a process for producing wound tubes from fiber-reinforced plastic such that precisely defined surfaces can be generated on the outer side without subsequent mechanical finishing.

According to the invention, the object for the process is accomplished in that the following steps are carried out in the process for producing a tube from fiber-reinforced plastic having a fitting face:

a) winding a fiber reinforcing material onto a winding core and applying a matrix material to form the tube,

b) centering a fitting shaping tool in relation to the winding core,

c) pushing the fitting shaping tool in the axial direction onto the later fitting face, which is formed on an annular part of the external circumferential face of the tube, wherein the fitting shaping tool rotates relative to the tube and to the winding core at least temporarily as it is being pushed on,

d) thermally treating the tube in a furnace to cure the matrix material, wherein the fitting shaping tool remains in contact with the annular part of the external circumferential face during the thermal treatment and, as a result, a defined surface (fitting surface) is generated by the fitting shaping tool on the outer side of the tube.

An advantage of this process is that the defined surface is embossed into the still formable matrix material by the fitting shaping tool prior to curing and is cured in the furnace in this form. A highly uniform and problem-free displacement or compaction of surplus matrix material is achieved by the pushing-on of the fitting shaping tool and by the associated, at least temporary, relative rotational movement between the fitting shaping tool and the tube. Very accurate faces, e.g. with a very smooth, even surface or with a precise diameter or with a precisely defined form, are possible as a result. An accurate coaxial form of the fitting face is assured by the fact that the fitting shaping tool is centered in relation to the winding core. Centering is carried out in such a way that it continues to be effective during the pushing-on operation. Centering preferably takes place as mechanical centering, for example by means of a centering pin which engages in a centering bore.

Such precise fitting faces are necessary as the basis for effective clamped or bonded connections, for example with metallic connecting components. Tubes having a surface which fits precisely internally and externally can be produced in a simplified manner by the process according to the invention. The inner side is determined by the winding core, and the annular region on the outer face is determined by the fitting shaping tool. Since this is possible without mechanical finishing, the tubes can be produced more rapidly and more cost effectively. The relative rotational movement can be achieved either by rotation of the fitting shaping tool or by rotation of the tube, e.g. by rotation of the winding core. Both parts can also rotate at a different speed or direction of rotation. The pushing-on process can take place either by active movement of the fitting shaping tool and/or by active movement of the tube.

The process according to the invention is particularly suitable for producing tubes with a fitting face, which exhibit an external diameter of between 30 and 500 mm, and preferably of between 80 and 300 mm, in the region of the fitting face, this diameter exhibiting a deviation from the nominal value of less than +/− 0.5 mm, and preferably of less than +/− 0.1 mm, in the region of the annular fitting face. It is also particularly suitable for producing tubes with a conically shaped fitting face, its cone angle being between 0.1° and 5°, and preferably between 0.1° and 1°, and the deviation from the nominal value of the cone angle being less than +/− 0.2°, and preferably less than +/− 0.05°.

A fiber reinforcement material made of glass fibers or aramide fibers or, most preferably, of carbon fibers is used for the production of the tube. Various other fibers can also be used. The fiber reinforcement can be applied at different angles and in several layers. In the process, the fibers are applied in the form of a winding of one or a plurality of parallel rovings or of woven tapes or mesh tapes respectively in a single layer or multiple layers or also in combination. The fiber reinforcement is surrounded by a plastic matrix. Thermoplastics or preferably thermosetting plastics, such as epoxy resin, are particularly suitable as a matrix material. The matrix material may already be present on the fiber reinforcement before winding, or it may be applied during or after winding. The curing or consolidation of the matrix material takes place by thermal treatment in the furnace, preferably at a temperature between 50° C. and 250° C.

Further advantageous characterizing features of the process according to the invention, which further improve the quality and the design possibilities of the surface or which simplify the process, can be found in the dependent claims.

Steps a)-d) are preferably carried out in the indicated sequence. However, individual steps can also be carried out in a different sequence or partly in parallel. For example, step b) can accordingly be carried out before step a) or in parallel to step c). The application of the matrix material in full or in part could also take place only during step c).

In any event, the fitting shaping tool is configured in such a way that it encloses the tube in its entirety in an annular region. Applications of the process according to the invention are also possible, however, in which the fitting shaping tool only bears against one part of the circumference with the intention that defined fitting faces are to be generated only on this part. The result is an interrupted annular fitting face. The fitting shaping tool preferably bears against a large part of the circumference on the surface of the tube, so that the fitting face is generated in a defined manner on a large part of the circumference. The expression large part is used to denote more than half, and preferably more than 70%, of the circumference. In particular, the fitting shaping tool can be in contact with the tube over its entire circumference in order to generate a continuous annular fitting face.

In the case of tapered, conical or curved faces, the fitting shaping tool can be configured in a single piece, for example; a simple, seam-free surface is thus possible. It may be of two-part or multi-part configuration in order to make it easier to apply and remove the fitting shaping tool, including in the case of conical or curved faces, or in order to be able to generate cylindrical or only slightly conically formed fitting faces. The individual parts of the fitting shaping tool are joined together prior to pushing on. Crushing of the metric material and inaccurate surface formation are avoided as a result. In this case, too, seam-free formation of the surface is assured by the relative rotation in the course of pushing on.

In order for controlled heating and associated effective curing also to be assured in the region of the fitting shaping tool, it is advantageous for the fitting shaping tool to be heated before or after it is brought into contact with the tube. Heating can take place, for example, by means of electrical heating cartridges inserted into holes in the fitting shaping tool. A cold fitting shaping tool would require a longer holding time in the furnace. The fitting shaping tool can also be heated prior to application and only then brought into contact with the tube. Heating can take place, for example, in a furnace or by means of some other heat source, such as with IR radiators.

A temperature sensor can be used in order to be able to monitor the temperature of the fitting shaping tool in the course of production of the fitting face, and/or a temperature controller can be used for heating the fitting shaping tool. This ensures that the matrix material is heated within a desired temperature window. An excessively low temperature will lead to insufficient curing, and an excessively high temperature can damage the matrix material and alter its properties in an undesired manner.

The fitting shaping tool can be configured in such a way that it generates a cylindrical surface having a constant diameter on the tube. A fitting seat for a further component, which is subsequently mounted on the tube, can thus be produced directly in this way. The process is particularly suitable for producing conical fitting faces at the end of the tube. The fitting shaping tool is formed in such a way for this purpose that it generates a conical surface on the tube (11). The diameter of the conical face preferably decreases towards the end of the tube. Conical fitting faces are suitable in particular in order to be able to produce an effective clamped connection between the tube and subsequently installed metal connectors, of the kind that are used, for example, in drill pipes for oil drilling. Fitting faces that are also not straight in their cross section can be generated with the process, for example a curved surface having a defined radius of curvature on the tube. The wave can exhibit a regular waveform. The advantage of such faces is that a certain axial force can be observed in the connection of the tube to other components. Fitting shaping tools can also be used which exhibit a combination of the previously mentioned fitting faces, which thus possess a cylindrical part and a conical part, for example.

In order to be able to produce tubes with high strength, carbon fibers which are preferably wrapped in the form of rovings are preferably used as a fiber reinforcement material. In particular in the case of very high strength requirements, it is advantageous if no mechanical surface machining is necessary, since the fibers in this case must not be exposed or damaged under any circumstances. The process finds a particularly advantageous application if the matrix material is a thermosetting plastic, in particular an epoxy resin. Curing temperatures of between 50° C. and 250° C. are necessary for this purpose.

Thermosetting plastics produce a hard surface, so that the saved mechanical machining has a particularly noticeable effect here.

If the fitting shaping tool is pressed against the external circumferential face, additional compaction can be achieved in this annular part of the tube, which further increases the strength and the load-bearing capacity. It is preferably pressed with a pressure that is greater than 0 bar and is up to 1 bar.

In the case of the tube according to the invention, the object is accomplished in that the tube is produced by the process according to the invention.

It is particularly preferable for the tube to be configured in such a way that it exhibits an external diameter of between 30 and 500 mm, and preferably of between 80 and 300 mm, in the region of the fitting face, this diameter exhibiting a deviation from the nominal value of less than +/− 0.5 mm, and preferably of less than +/− 0.1 mm, in the region of the annular fitting face. It is also particularly preferable for the tube to exhibit a conically shaped fitting face, the cone angle of which is between 0.1° and 5°, and preferably between 0.1° and 1°, and in which the deviation from the nominal value of the cone angle is less than +/− 0.2°, and preferably less than +/− 0.05°.

Further advantageous characterizing features of the invention are described below on the basis of illustrative embodiments with reference to the drawings. The aforementioned characterizing features are capable of being implemented advantageously not only in the depicted combination, but also when combined individually with one another.

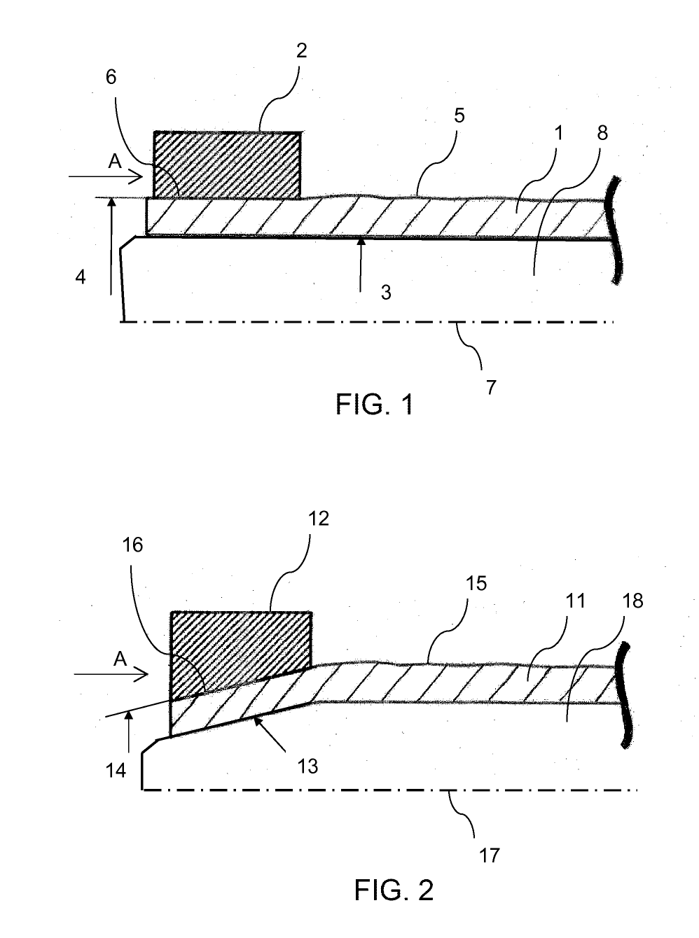

FIG. 1 Tube with a cylindrical tool for the process according to the invention

FIG. 2 Tube with a conical tool for the process according to the invention

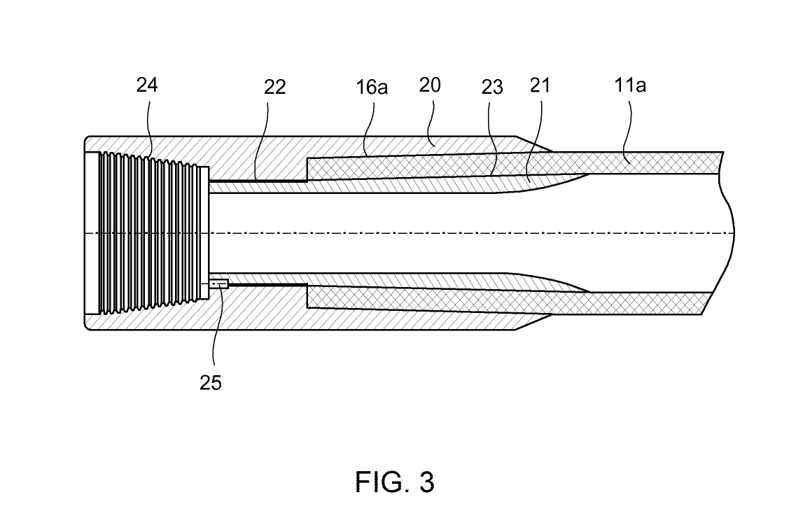

FIG. 3 Tube element for drill pipes with a CRP tube produced according to the process according to the invention.

The figures are described below in more detail. FIG. 1 depicts a detail as an example of the production of a tube having a cylindrical fitting face. The tube 1 is preferably made of CRP (Carbon Fiber-Reinforced Plastic). The center line 7 indicates that only the upper half is represented in cross section. The tube has been wound onto the winding core 8 by winding fiber material, for example rovings or woven tapes or mesh tapes, in one or more layers, and by applying matrix material, for example thermosetting resin. The winding core 8 defines the inner face and determines the internal diameter 3. If necessary, the inner face can also be conical in shape.

The fitting shaping tool 2 has been pushed onto the still-formable matrix material of the tube 1 after winding while rotating at least temporarily relative to the tube in the axial direction A. The fitting shaping tool can preferably be heated and can be combined with a temperature sensor and/or a temperature controller. An annular cylindrical fitting face 6 is produced in the region of the contact face between the fitting shaping tool and the tube 1. The fitting face is formed precisely in the desired form as a result of the fitting shaping tool being applied prior to curing and remaining on the tool during curing in the furnace. An accurate and problem-free embodiment of the desired fitting face is made possible by pushing on while rotating at least temporarily. Before pushing on, the fitting shaping tool was centered in relation to the winding core 8, for example by means of a centering pin which engages in a centering bore. This involves carrying out the centering, which is not depicted here, in such a way that the fitting shaping tool remains centered during the pushing-on process. The rest of the outer face 5 of the tube remains imprecise in this example, in the form in which it emerges after winding the tube. After shaping the fitting face, the tube 1 is cured in contact with the fitting shaping tool 2 in a furnace.

FIG. 2 depicts a similar example of the production of a conical fitting face. The center line 17 is indicated in this case, too. The tube 11 is wound onto a winding core 18 tapering towards the end of the tube, which determines the inner face 13 in a defined manner. The fitting shaping tool 12, which in this case, too, has been pushed on while rotating at least temporarily in the axial direction A, likewise generates on the outer side of the tube a cone 16 having a precisely defined conical surface 14 tapering towards the end of the tube. In this case, too, the fitting shaping tool 2 was centered in relation to the winding core 8 before pushing on, for example by means of a centering pin which engages in a centering bore.

The centering, which is not depicted here, is carried out in such a way that the fitting shaping tool 12 remains centered during the pushing-on process. The wound surface next to the tool 12 remains untreated here for the time being. After shaping the fitting face, the tube 11 is cured in contact with the fitting shaping tool 12 in a furnace.

An example of an application is depicted in FIG. 3. This is a tubular element, of the kind that can be used for the assembly of a drill pipe for oil drilling. In this case, a metal connector 20, which exhibits a tapered thread 24 for screwing together with further tube elements to form a string, must be connected to the CRP tube 11a. The connection must be capable of transmitting high torques and axial forces. In order to make this possible, the metal connector 20 is connected to a counter-sleeve 21 via a cylindrical screwed connection 22 and a locking element in the form of a subsequently introduced pin. The end of the tube 11a is clamped between the counter-sleeve 21 and the metal connector 20. Adequate clamping forces can be generated because of the conical shape. Precise conical fitting faces are required on the inner side and the outer side of the tube, however, for a good connection. The inner fitting face 23 is produced via the winding core in the course of production. The outer fitting face 16a via the process according to the invention with a fitting shaping tool, as described above. Further possible applications for the production process present themselves for other tube connections or for add-on components which are dependent on a precise external surface of the tube.

### LIST OF REFERENCE DESIGNATIONS

1, 11, 11a CRP tube
2, 12 fitting shaping tool
3 internal diameter of the CRP tube
4 external diameter for the fitting face
5, 15 outer face of the CRP tube
6, 16, 16a fitting face
7, 17 center-line of CRP tube
8, 18 winding core
13 inner face of the CRP tube
14 conical face of the fitting face
20 metal connector
21 counter-sleeve
22 cylindrical screwed connection
23 inner fitting face of the CRP tube
24 tapered thread
25 locking pin
A axial direction of the pushing-on movement

1-15. (canceled)

16. A process for producing a tube of fiber-reinforced plastic having a fitting face, the process comprising the following process steps:
a) winding a fiber reinforcing material onto a winding core and applying a matrix material to form the tube;
b) centering a fitting shaping tool relative to the winding core;
c) pushing the fitting shaping tool in an axial direction onto a fitting face to be formed, the fitting face to be formed on an annular part of an external circumferential face of the tube, and thereby rotating the fitting shaping tool at least temporarily relative to the tube and to the winding core as the fitting shaping tool is being pushed on;
d) thermally treating the tube in a furnace to cure the matrix material, maintaining the fitting shaping tool in contact with the part of the external circumferential face during the thermal treatment to generate a defined surface on the outer side of the tube by the fitting shaping tool.

17. The process according to claim 16, which comprises carrying out steps a) to d) one after another in a sequence a) then b) then c) then d).

18. The process according to claim 16, wherein the fitting shaping tool is a two-part tool with two parts, and the method comprises joining the two parts of the tool together prior to step b).

19. The process according to claim 16, wherein the fitting shaping tool is a multi-part tool with a plurality of parts, and the method comprises joining the plurality of parts of the tool together prior to step b).

20. The process according to claim 16, which comprises heating the fitting shaping tool before or while the tool is brought into contact with the tube.

21. The process according to claim 20, wherein the fitting shaping tool is a heated tool that had been heated previously before the tool is brought into contact with the tube.

22. The process according to claim 20, which comprises using a temperature sensor on the fitting shaping tool and/or using a temperature controller for heating the fitting shaping tool.

23. The process according to claim 16, wherein the fitting shaping tool is configured to generate a cylindrical surface having a constant external diameter on the tube.

24. The process according to claim 16, wherein the fitting shaping tool is configured to generate a conical surface on the tube.

25. The process according to claim 16, wherein the fitting shaping tool is configured to generate a curved surface with a defined radius of curvature on the tube.

26. The process according to claim 16, wherein the fiber reinforcing material is selected from the group consisting of carbon fibers, glass fibers. and aramide fibers.

27. The process according to claim 26, wherein the fibers of the reinforcing material are wrapped onto the winding core in the form of rovings.

28. The process according to claim 16, wherein the matrix material is a thermosetting plastic.

29. The process according to claim 16, wherein the matrix material is an epoxy resin.

30. The process according to claim 16, which comprises pressing the fitting shaping tool against the external circumferential face with a pressure that is greater than 0 bar and no more than 1 bar.

31. A tube, comprising a tube body of fiber-reinforced plastic formed with an annular fitting face produced in a process according to claim 16.

32. The tube according to claim 31, wherein said tube has an external diameter in a region of said fitting face between 30 and 500 mm and the diameter deviates from the nominal value by less than +/− 0.5 mm in the region of the annular fitting face.

33. The tube according to claim 32, wherein the external diameter in the region of said fitting face lies between 80 and 300 mm, and the diameter deviates from the nominal value by less than +/− 0.1 mm in the region of the annular fitting face.

34. The tube according to claim 31, wherein said fitting face is conically shaped, with a cone angle between 0.1 ° and 5°, and wherein a deviation from the nominal value of the cone angle is less than +/− 0.2°.

35. The tube according to claim 34, wherein the cone angle lies between 0.1 ° and 1°, and the deviation from the nominal value of the cone angle is less than +/− 0.05 °.
